(19) United States
(12) Patent Application Publication
(10) Pub. No.: US 2011/0274041 A1
(43) Pub. Date: Nov. 10, 2011

(54) DYNAMIC PEER DISCOVERY AND INTER-UNIT TRANSFER (IUT) USING MOBILE INTERNET PROTOCOL (MIP)

(75) Inventors: Michelle Perras, Montreal (CA); Kamel M. Shaheen, King of Prussia, PA (US)

(73) Assignee: InterDigital Patent Holdings, Inc., Wilmington, DE (US)

(21) Appl. No.: 13/040,547

(22) Filed: Mar. 4, 2011

Related U.S. Application Data
(60) Provisional application No. 61/310,779, filed on Mar. 5, 2010.
(60) Provisional application No. 61/320,581, filed on Apr. 2, 2010.

(51) Int. Cl. H04W 4/00

(52) U.S. Cl. 370/328

(57) ABSTRACT

Methods and systems for a mobile node of a communication network to use mobile internet protocol (MIP) to query a node, such as a home agent (HA) of the communication network to obtain information regarding other nodes that may be registered with the same node of the network, such as the HA, or nodes that may be registered with the same HoA. Also, a node of a communication network, such as a HA, may send to registered nodes of the communication network via MIP un-requested information regarding nodes that may be registered with the HA, or nodes that may be registered with the same HoA. A node of the communication network may initiate an inter-unit transfer (IUT) to one or more other nodes of the communication network using the information regarding nodes that may be registered with the HA or registered with the same HoA.

### CROSS REFERENCE TO RELATED APPLICATIONS

This application claims the benefit of U.S. Provisional Application No. 61/310,779 filed Mar. 5, 2010, titled “INTER-UNIT TRANSFER SUPPORT USING NEW MOBILE INTERNET PROTOCOL DEVICE IDENTIFIER”, and U.S. Provisional Application No. 61/320,581, filed Apr. 2, 2010, titled “DYNAMIC PEER DISCOVERY USING MOBILE IP”, the contents of both applications are hereby incorporated by reference herein in their respective entirety, for all purposes.

### BACKGROUND

Users of equipment such as cell phones and other user devices that may be in communication with a wireless communications network may wish to transfer information, data, media application streams, media sessions, and the like, among devices that are also in communication with the wireless communication network. The source devices and target devices may be peers on the communication network. The user devices, or peer devices, among which transfer may occur, may be referred to as user equipment (UE) or a wireless transmit/receive unit (WTRU). Such transfer among user equipment may be referred to as inter-unit transfer or inter-user equipment transfer (IUT).

Devices that may potentially participate in an IUT may or may not be pre-configured for such transfers. Before triggering the IUT, a source device (source WTRU) may want to confirm that the target device (target WTRU) may be active and ready to accept the data transfer. For example, a WTRU may need to know the status of a peer WTRU regarding its ability to accept a transfer (IUT). Also, a WTRU may need information regarding a peer WTRU to allow inter-user transfer to occur.

### SUMMARY

This Summary is provided to introduce a selection of concepts in a simplified form that are further described below the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Embodiments contemplate that peer discovery may be used to support Inter-Unit Transfer (JUT). For example, registered devices may use a mobile internet protocol to request from the communication network, or a node of the network, information concerning other devices registered with the network. The communication network, or a node of the network, may provide such information to registered devices with or without responding to a request from the registered device.

Embodiments contemplate a mobile node or UE of a communication network may use mobile internet protocol (MIP) to query a home agent (HA) of the communication network to obtain information concerning other nodes or devices that may be registered with the same home address (HoA).

Embodiments contemplate a node of a communication network, such as a home agent (HA) may send un-requested information (or indications) concerning nodes or devices that may be registered with the same home address (HoA) to registered devices of the communication network.

Embodiments contemplate Mobile IP (MIP) may be modified to track possible target device (UE) availability and also may obtain the information required to initiate a device transfer (IUT).

Embodiments contemplate Dynamic Peer Discovery may allow the exchange of information useful to IUT via the Home Agent (HA) node of a communication network. A Peer Discovery Addition in MIP protocol may carry a list of registered devices that may share the same HoA. MIP based query messages may be introduced to collect the peer device information that may be used for IUT.

Embodiments contemplate indication support in MIP protocol may be used to modify the usage of response messages with an MIP indication message that may be sent without having previously received a request, thereby providing indication support of registered devices that may share the same HoA. Extended Binding Update/Acknowledge messages that may include a new flag, such as “I”, may specify if MIP based indications of registered devices that may share the same HoA are supported. Also, a message in MIP protocol may be introduced for indication support that may be referred to as “Peer Indication”, for example.

Embodiments contemplate a method for identifying nodes in a communication network may comprise sending a first signal (or message) to a first node of the communication network. The first signal (or message) may indicate a capability of a second node to register with the first node. The method may also include receiving information from the first node. The information may further include data identifying one or more additional nodes registered with the first node.

Embodiments contemplate modifications to existing mobile Internet protocol (MIP) messaging and architectures for transferring data between wireless transmit/receive units (WTRUs). New messages may be used to trigger an inter-unit transfer (IUT) operation. These new messages may identify the target device, the media components to be transferred and, if necessary, any adjustment in quality of service (QoS). Some or all devices associated with a specific subscriber may be registered with a home agent (HA) and may share the same home address (HoA). A binding update (BU) that may use a new WTRU identifier (WTRUID) extension may be sent to the HA by some or all devices. Different binding entries, sharing the same HoA but with different care-of-addresses (CoAs)/WTRUIDs, may be saved on the HA. Target devices may be registered with the HA before an IUT procedure may be initiated for these devices. Flow bindings, specifying to which binding a specific flow may be redirected, may be created, modified, and/or deleted using an HoA/WTRUID/binding identification (BID) triplet. Separate flows may be registered (e.g., for voice, video) using traffic selectors. The different flows may be handled separately and may be forwarded to different target WTRUs.

Embodiments contemplate that an IUT may be enabled by allowing flow transfer between one or multiple devices using MIPv6 flow mobility, for example. A WTRU identifier (WTRUID) may be added in a binding entry definition. Binding entries in the binding table may be uniquely identified using an HoA/BID/WTRUID triplet, for example.

Embodiments contemplate that the WTRUID may be added in a flow binding definition. Flow entries may be uniquely identified using an HoA/WTRUID/FID triplet, for example. Flow entries may point to binding entries that may be uniquely identified using an HoA/BID/WTRUID triplet, for example.

Embodiments contemplate that a mobility addition (option) may be added to carry the WTRUID in the MIPv6 protocol. Embodiments also contemplate that existing binding identifier mobility addition (option) and the existing binding reference mobility addition (option) may be modified to include the WTRUID. Embodiments contemplate that an independent controller and/or a master controller IUT technique may be supported by these additions and modifications. A new master controller addition (option) may be introduced to advertise which WTRU is the master controller in the MIPv6 protocol, for example.

Embodiments contemplate a wireless transmit/receive unit (WTRU) that may be configured, at least in part, to communicate with a first node of a wireless communication network and to transmit a first message. The first message may utilize mobile Internet Protocol (MIP). The WTRU may also be configured to receive a second message in response to the first message. The second message may utilize MIP and the second message may include information regarding a second node of the wireless communication network. The second node may be configured to communicate with the first node. Embodiments contemplate that the first node may be a home agent, and the WTRU and/or the second node may be registered with the home agent. Embodiments contemplate that the information regarding the second node may include at least one of a home address (HoA), a node identification (Node ID) (that may also be a WTRU ID), a binding identification (Binding ID), a routing Care of Address (CoA), and/or a flow identification (Flow ID).

Embodiments contemplate that the WTRU may be configured to transmit a third message to the home agent. The third message may utilize MIP and the third message may include a WTRU identification (WTRU ID) in at least one of a WTRU ID extension or a binding identifier extension. The WTRU ID may be at least one of an International Mobile Equipment Identifier (IMEI), a WTRU serial number, an Internet Protocol (IP) address, and/or a predetermined number.

Embodiments contemplate a wireless transmit/receive unit (WTRU) that may be configured, at least in part, to communicate with a first node of a wireless communication network and to receive a first message. The first message may be unsolicited and may utilize mobile Internet Protocol (MIP), and the first message may include information regarding a second node of the wireless communication network. The second node may be configured to communicate with the first node. Embodiments contemplate that the first node may be a home agent, and at least one of the WTRU or the second node may be registered with the home agent. Embodiments contemplate that the first message may be received from the home agent and the first message may include an extension, where the extension may include the information regarding the second node.

Embodiments contemplate the WTRU may be further configured to interpret the information regarding the second node from the extension. The WTRU may also be configured to transmit a binding update to the home agent. The binding update may utilize MIP and the binding update may include an indication that the WTRU may be configured to interpret the information regarding the second node from the extension. The WTRU may also be configured to receive a binding acknowledgement from the home agent. The binding acknowledgement may utilize MIP and the binding acknowledgment may include an indication that the home agent may be configured to provide the information regarding the second node in the extension.

Embodiments contemplate a wireless transmit/receive unit (WTRU) configured, at least in part, to receive a media flow from a first node of a wireless communication network and to receive a first message that may include information regarding a second node of the wireless communication network. The first message may utilize mobile Internet Protocol (MIP). The WTRU may also be configured to transmit a second message to a third node of the wireless communication network. The second message may utilize MIP and the second message may initiate an inter-unit transfer (IUT) of at least a part of the media flow from the WTRU to the second node. Embodiments contemplate that the information regarding the second node may include at least one of a home address (HoA), a node identification (Node ID) (that may also be a WTRU ID), a binding identification (Binding ID), a routing Care of Address (CoA), or a flow identification (Flow ID).

Embodiments contemplate the second message may initiate the IUT, at least in part, by at least one of deleting a first traffic selector corresponding to the WTRU or creating a second traffic selector corresponding to the second node. The second traffic selector may be stored on the third node and the second traffic selector may indicate a flow direction of the at least part of the media flow to the second node. The second traffic selector may correspond to a Flow ID and the Flow ID may correspond to at least one of a Binding ID, a HoA, or a Node ID (that may also be a WTRU ID). Embodiments contemplate that the third node may be a home agent, and at least one of the WTRU or the second node may be registered with the home agent, and the first node may be a streaming media server.

### BRIEF DESCRIPTION OF THE DRAWINGS

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of another example radio access network and an example core network that may be used within the communications system illustrated in FIG. 1A;

FIG. 2 illustrates an exemplary embodiment of a network in which media flows may be transferred among peer devices in a manner consistent with embodiments;

FIG. 3 illustrates an example embodiment of a network in which mobile nodes may register with a node of the network consistent with embodiments;

FIG. 4 illustrates an example embodiment of an extension in a mobile internet protocol consistent with embodiments;

FIG. 5 illustrates an example embodiment of indication support in a mobile internet protocol consistent with embodiments;

FIG. 6 illustrates an example embodiment of a node peer update with a mobile internet protocol based query consistent with embodiments;

FIG. 7 illustrates an example embodiment of a node peer update with an indication appended to a mobile protocol based message consistent with embodiments;

FIG. 8 illustrates an example embodiment of a node peer update with a mobile protocol based indication consistent with embodiments;

FIG. 9 illustrates an example of a system architecture for an IUT consistent with embodiments;

FIG. 10 illustrates an exemplary binding table with a binding entry and flow binding consistent with embodiments;

FIG. 11 illustrates an exemplary IUT scheme that utilizes an independent controller technique consistent with embodiments;

FIG. 12 illustrates an exemplary IUT scheme that utilizes a master controller technique consistent with embodiments;

FIG. 13 illustrates an exemplary MIP extension consistent with embodiments;

FIG. 14 illustrates an exemplary MIP extension being added to a binding identifier consistent with embodiments;

FIG. 15 illustrates an exemplary MIP extension being added to a binding reference consistent with embodiments;

FIG. 16 illustrates an exemplary MIP master controller extension consistent with embodiments;

FIG. 17 illustrates a flowchart of an exemplary peer discovery technique consistent with embodiments;

FIG. 18 illustrates a flowchart of another exemplary peer discovery technique consistent with embodiments; and

FIG. 19 illustrates a flowchart of an exemplary IUT technique consistent with embodiments.

### DETAILED DESCRIPTION OF ILLUSTRATIVE EMBODIMENTS

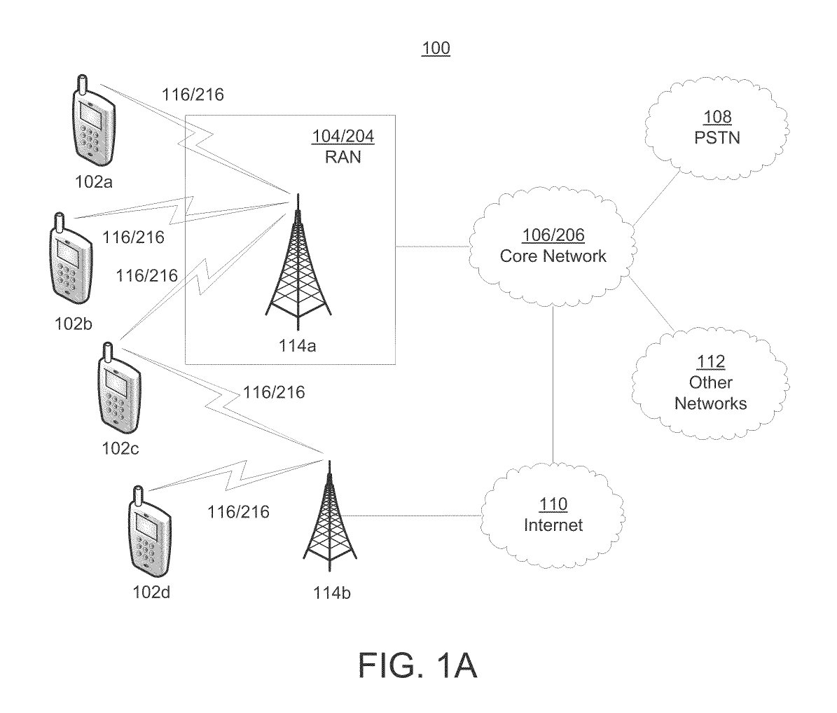

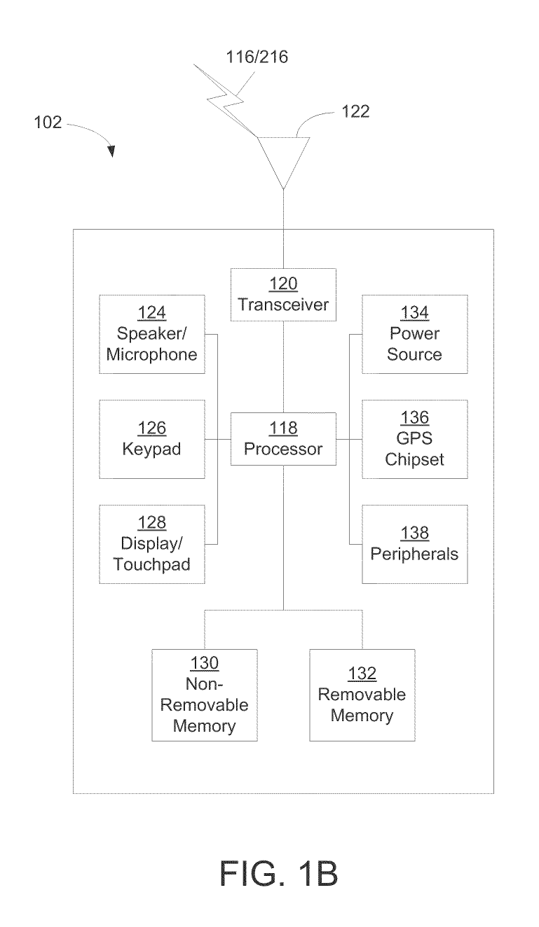

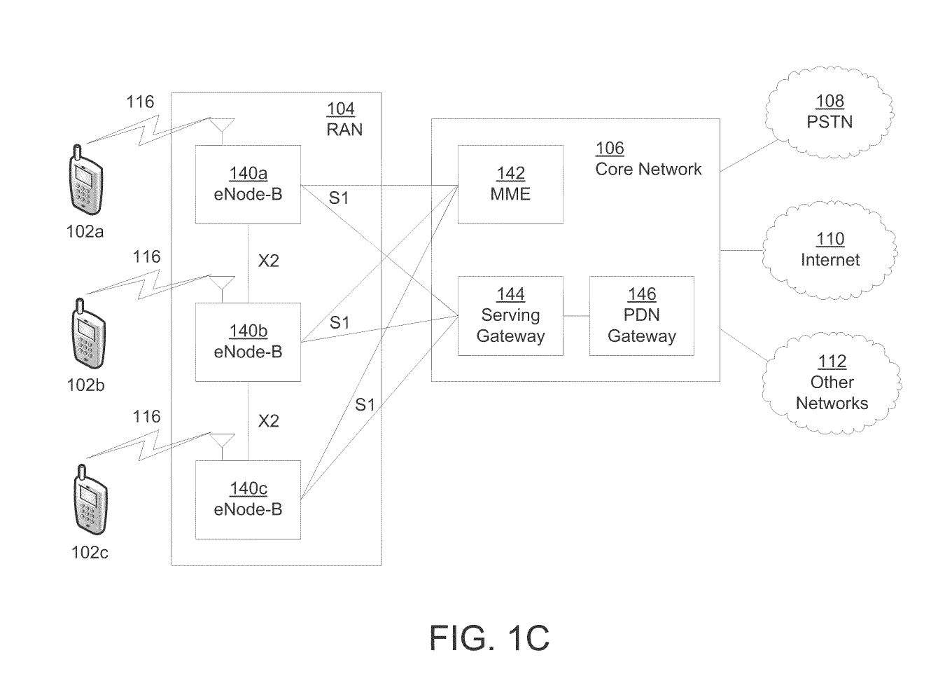

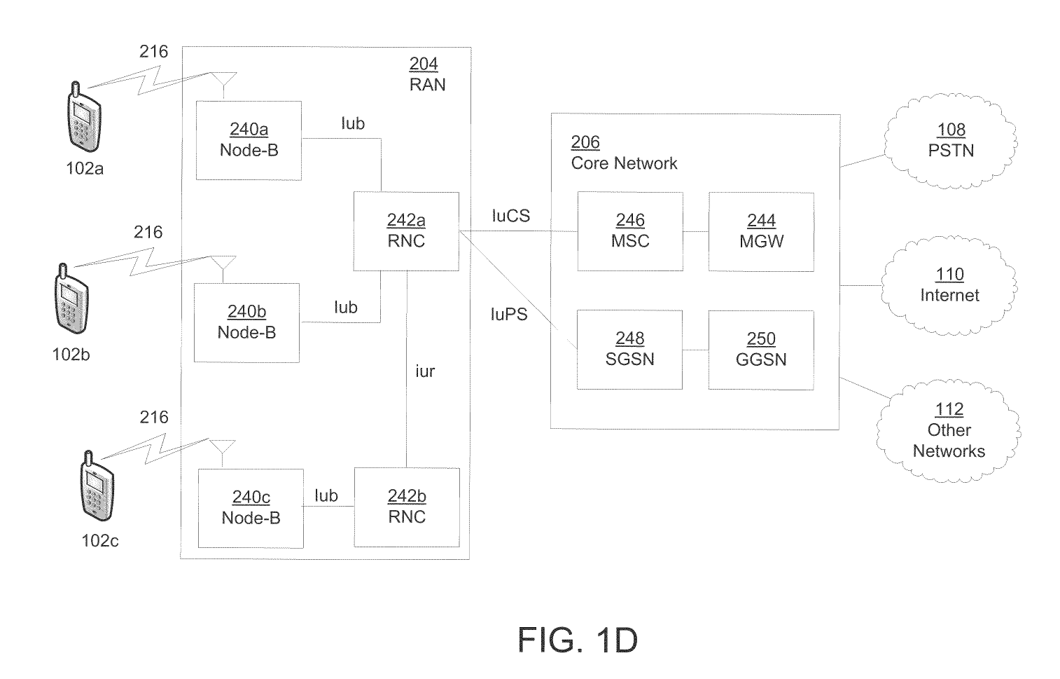

A detailed description of illustrative embodiments will now be described with reference to FIGS. 1-19. Although this description provides a detailed example of possible embodiments, it should be noted that the details are intended to be exemplary and in no way limit the scope of disclosed embodiments.

When referred to herein, the terminology “wireless transmit/receive unit (WTRU)” may include but is not limited to a user equipment (UE), a mobile station (MS), an advanced mobile station (AMS), a fixed or mobile subscriber unit, a pager, a cellular telephone, a personal digital assistant (PDA), a computer, or any other type of device capable of operating in a wireless environment.

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104/204, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/206, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/204, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/204 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA20001x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/206.

The RAN 104/204 may be in communication with the core network 106/206, which may be any type of network configured to provide voice, data, applications, and/or voice over internet protocol (VoIP) services to one or more of the WTRUs 102a, 102b, 102c, 102d. For example, the core network 106/206 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/204 and/or the core network 106/206 may be in direct or indirect communication with other RANs that employ the same RAT as the RAN 104/204 or a different RAT. For example, in addition to being connected to the RAN 104/204, which may be utilizing an E-UTRA radio technology, the core network 106/206 may also be in communication with another RAN (not shown) employing a GSM radio technology.

The core network 106/206 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104/204 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, and/or 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, and/or 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1D is a system diagram of the RAN 204 and the core network 206 according to an embodiment. As noted above, the RAN 204 may employ a UTRA radio technology to communicate with the WTRUs 102a, 102b, and/or 102c over the air interface 116. The RAN 204 may also be in communication with the core network 206. As shown in FIG. 1C, the RAN 204 may include Node-Bs 240a, 240b, 240c, which may each include one or more transceivers for communicating with the WTRUs 102a, 102b, 102c over the air interface 216. The Node-Bs 240a, 240b, 240c may each be associated with a particular cell (not shown) within the RAN 204. The RAN 204 may also include RNCs 242a, 242b. It will be appreciated that the RAN 204 may include any number of Node-Bs and RNCs while remaining consistent with an embodiment.

As shown in FIG. 1D, the Node-Bs 240a, 240b may be in communication with the RNC 242a. Additionally, the Node-B 240c may be in communication with the RNC 242b. The Node-Bs 240a, 240b, 240c may communicate with the respective RNCs 242a, 242b via an Iub interface. The RNCs 242a, 242b may be in communication with one another via an Iur interface. Each of the RNCs 242a, 242b may be configured to control the respective Node-Bs 240a, 240b, 240c to which it is connected. In addition, each of the RNCs 242a, 242b may be configured to carry out or support other functionality, such as outer loop power control, load control, admission control, packet scheduling, handover control, macrodiversity, security functions, data encryption, and the like.

The core network 206 shown in FIG. 1D may include a media gateway (MGW) 244, a mobile switching center (MSC) 246, a serving GPRS support node (SGSN) 248, and/or a gateway GPRS support node (GGSN) 250. While each of the foregoing elements are depicted as part of the core network 206, it will be appreciated that any one of these elements may be owned and/or operated by an entity other than the core network operator.

The RNC 242a in the RAN 204 may be connected to the MSC 246 in the core network 206 via an IuCS interface. The MSC 246 may be connected to the MGW 244. The MSC 246 and the MGW 244 may provide the WTRUs 102a, 102b, 102c with access to circuit-switched networks, such as the PSTN 108, to facilitate communications between the WTRUs 102a, 102b, 102c and traditional land-line communications devices.

The RNC 242a in the RAN 204 may also be connected to the SGSN 248 in the core network 206 via an IuPS interface. The SGSN 248 may be connected to the GGSN 250. The SGSN 248 and the GGSN 250 may provide the WTRUs 102a, 102b, 102c with access to packet-switched networks, such as the Internet 110, to facilitate communications between and the WTRUs 102a, 102b, 102c and IP-enabled devices.

As noted previously, the core network 206 may also be connected to the networks 112, which may include other wired or wireless networks that are owned and/or operated by other service providers.

Embodiments contemplate that the Internet protocol (IP) multimedia subsystem (IMS) may be an architectural framework for delivering IP-based multimedia services. A wireless transmit/receive unit (WTRU) may connect to an IMS through various access networks, including but not limited to networks based on technology such as universal mobile telecommunications system (UMTS) terrestrial radio access network (UTRAN), long term evolution (LTE), worldwide interoperability for microwave access (WiMax), or wireless local area network (WLAN) technology. The WTRU may access the IMS through a packet-switched (PS) domain. Through the use of IMS centralized services (ICS), the WTRU may additionally access IMS services via a circuit-switched (CS) domain.

Embodiments contemplate that IUT may allow a communication session to be transferred from one WTRU to another. Embodiments also contemplate media mobility solutions for non-IMS terminals, (e.g., packet switched streaming (PSS) services capable terminals, real time streaming protocol (RTSP)/real time control protocol (RTCP) terminals, and hyper text transfer protocol (HTTP) streaming terminals) to engage in IUT. Embodiments contemplate that not all systems may support IMS, and not all terminals may be capable of supporting SIP. Embodiments recognize that there may be a need to perform an IUT operation for non-IMS terminals and/or in non-IMS systems. Embodiments contemplate the enhancement of mobile IP (MIP) protocol to support session mobility (e.g., session continuity and/or media mobility) in addition to third generation partnership project (3GPP) systems that may support media mobility for devices that may support an IMS-session initiation protocol (SIP).

Embodiments contemplate that Internet engineering task force (IETF) mobile IP (MIP) and IP flow mobility may be provided by MIPv6, for example, for which a binding table may exist where a home address (HoA) may be associated with a care-of-address (CoA). The CoA may be updated when the user moves to another location/technology. Embodiments also contemplate that IETF MIP and IP flow mobility may also be provided by dual Stack MIPv6-DSMIP which may allow the registration of IPv4 and/or IPv6 addresses and prefixes, and may allow the transport of IPv4 and/or IPv6 packets over a tunnel to a home agent, and may allow the mobile node to roam over IPv6 and/or IPv4.

Embodiments also contemplate that IETF MIP and IP flow mobility may also be provided by multiple bindings, which may introduce binding identification (BID) mobility extension in binding update (BU)/binding acknowledgement (BA)—for example, and may enable the creation of multiple binding entries on a home agent (HA) or correspondent node (CN). For example, multiple CoAs may be associated to an HoA, and the WTRU may generate a BID for each CoA.

Embodiments contemplate that IETF MIP and IP flow mobility may also be provided by flow bindings, which may introduce flow identification (FID) mobility extension in BU/BA, and may introduce the concept of flows, and may allow the binding of a particular flow to one or more CoAs (i.e., binding entry) without affecting other flows using the same HoA. Traffic selectors may be used to identify flows (as compared with incoming IP packets, for example), and specified policies associated with each binding entry may be allowed. Embodiments contemplate that policies may use traffic selectors and that actions associated to policies may include delete or forward to the associated CoA (IP packets), for example.

Embodiments contemplate that 3GPP IP flow mobility may be based on multiple bindings and/or flow bindings. To achieve IP flow mobility, embodiments contemplate that the inter-system mobility signaling may be enhanced in order to carry routing filters. Also embodiments contemplate the extensions to DSMIPv6 mobility signaling that may be needed to carry routing filters when the WTRU may be connected to multiple accesses simultaneously.

Embodiments contemplate IP flow mobility between multiple devices (e.g., WTRUs). Embodiments recognize that using MIP to transfer data flows (e.g., IUT) between multiple WTRUs may be useful, in addition to IP flow mobility for devices that may have multiple interfaces (e.g., flow mobility between interfaces on a single device).

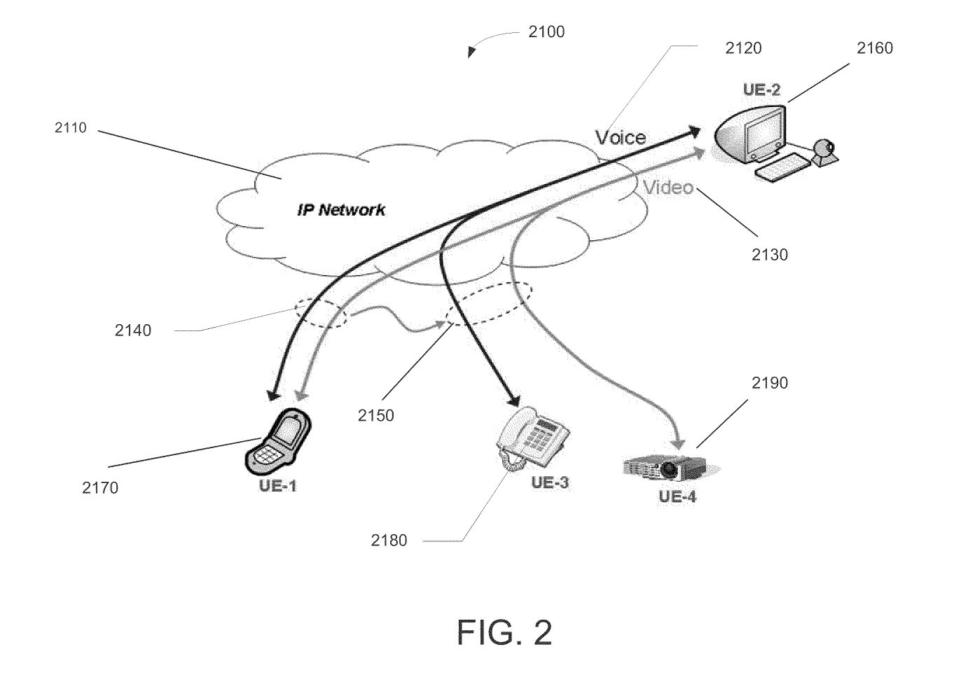

FIG. 2 illustrates an example embodiment of a system 2100 transferring a media session control between terminals. Embodiments contemplate the transfer of media flows, or parts or components of media flows, from one terminal, such as the mobile device 2170, to a second terminal, such as the computer 2160. For example, a mobile device user may decide to transfer the voice component, such as voice component 2120, of a media session to a fixed phone, such as the fixed phone 2180, and the video component, such as the video component 2130, of the same media session to a video projection, such as the projector 2190. Embodiments contemplate that the system 2100 may include the IP network 2110. The IP network 2110 may be a network such as a Public Land Mobile Network (“PLMN”), an IMS network, corporate intranet, a Fixed-End System (“FES”), the public Internet, or the like. Further, the system 2100 and/or the IP network 2110 and/or one or more of the devices depicted in FIG. 2 may support Mobile Internet Protocol (MIP). Although not shown, embodiments contemplate that network elements such as routers, gateways switches, and/or the like, may be included within the IP network 2110.

As illustrated in FIG. 2, the IP network 2110 may be in operative communication with one or more mobile nodes, wireless transmit/receive units (WTRU) (or UEs), such as the mobile device 2170. The network 2110 may also be in operative communication with the fixed phone 2180, the projector 2190, the computer 2160, or the like. The configurations and the communications between the IP network 2110 and the mobile devices or WTRUs are examples, and as such, the communications between the specified WTRUs may be between different elements and/or through additional elements as well as different signaling/commands may be used.

Embodiments contemplate that a user associated with the mobile device 2170 may establish a multimedia flow with a remote party associated with the computer 2160. The multimedia flow may include one or more media components, such as the voice component 2120 and/or the video component 2130. The fixed line 2180 and/or the projector 2190 may be in operative connection with the IP network 2110, the mobile device 2170 and/or the computer 2160. The fixed line 2180 and the projector 2190 may, for example, belong to one or more IMS subscriptions that differ from the IMS subscription of the mobile device 2170. Additionally, the fixed line 2180 and the projector 2190 may belong to one or more network operators that differ from the network operator of the mobile device 2170.

A multimedia flow between the fixed line 2180 and/or the projector 2190 may be established with the remote party, such as the computer 2160. The media flow may then be received at both the fixed line 2180 and/or the projector 2190. Additionally or alternatively, the media flow may be broken into components that may then be received by the fixed line 2180 and/or the projector 2190. For example, the voice component 2120 of media flow may be transferred to the fixed line 2180 and the video component of the media flow may be transferred to the projector 2190. When the media flow is received at the fixed line 2180 and/or the projector 2190, a collaborative session 2150 may then be established. Collaborative session control may then be transferred from mobile device 2170 to the fixed line 2180 or the projector 2190. For example, the collaborative session 2150 may then permit the fixed line 2180 and/or the projector 2190 to maintain control over the voice component 2120 and/or the video component 2130. In one embodiment, the collaborative session 2140 may be terminated after collaborative session control and/or control over the media flow is transferred to the collaborative session 2150.

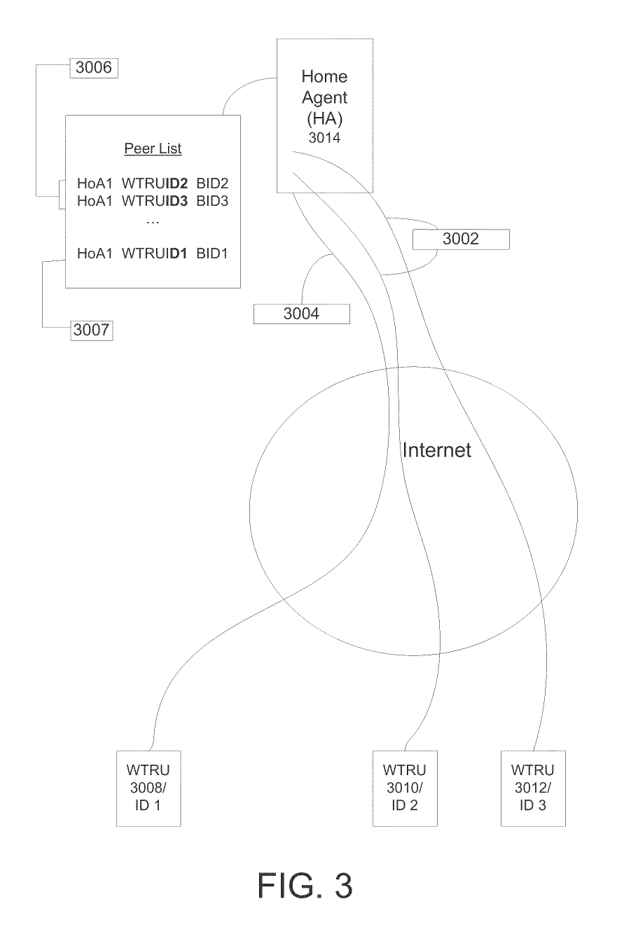

FIG. 3 illustrates an exemplary system contemplated by embodiments, similar to the system illustrated in FIG. 2, in which dynamic peer discovery may be carried out. Referring to FIG. 3, at 3002, WTRU 3010 and WTRU 3012 may do MIP registration with Home Agent (HA) 3014. WTRU 3010 and WTRU 3012 may be identified as “peers” in that they may be registered with the same home address (HoA) as seen at 3006. Embodiments also contemplate that WTRU 3008, WTRU 3010, and/or WTRU 3012 may belong to the same subscriber and/or the same operator.

Continuing to refer to FIG. 3, at 3004, WTRU 3008 may be powered ON and may do MIP registration with the HA 3014. Upon registration, WTRU 3008 may be added to the existing peer list on the HA 3014, for example, at 3007. Embodiments contemplate that the peer list may be queried by one or more of the WTRUs (WTRU 3008, WTRU 3010, or WTRU 3012). Alternatively or additionally, information from the peer list may be communicated to the WTRUs by the HA 3014 without a query by the one or more WTRUs. In other words, the HA may send the peer list information to the WTRUs without any specific request from the WTRUs for any peer list information (e.g., non-requested). For purposes of example, and not limitation, the non-requested peer list information communication may be made periodically, as a new update to the peer list occurs (e.g., a new peer node is added or dropped), and/or as an unsolicited peer information indication, which WTRU's may signal (e.g., via a message) that they may be capable of interpreting. For example, an unsolicited peer information indication may be sent by HA to one or more WTRUs that may have indicated that they support/want to receive unsolicited peer information indications, using a flag for example.

Again for purposes of example, and not limitation, embodiments contemplate that the peer list in FIG. 3 (e.g., “peer information”) may include one or more of an HA Identification (HA ID), a home address (HoA) an WTRU (or UE or “Node”) Identification, a List of Binding Identifications (Binding ID or BID) that may be associated with each WTRU, a List of IP flow Identifications (Flow ID or FID) that may be associated with one or more bindings, Care-of Addresses (CoA), capabilities, and/or Indications of a Master UE and a Slave UEs, among other parameters or information.

Embodiments contemplate that a Dynamic Discovery may be conducted in a Direct device-to-device communication mode. Communications such as, but not limited to Bluetooth, among others may be used for the direct device-to-device discovery mode. Embodiments contemplate that the devices involved in direct device-to-device dynamic discovery may be physically close to each other.

Alternatively or additionally, embodiments contemplate that in communication networks such as those that may involve the use of a home agent (HA), the devices involved in peer discovery may be physically proximate, or far away from each other. Embodiments contemplate that one or more peer devices may query the HA using a Mobility Addition that may be referred to as, for example, “Peer Discovery.” The Peer Discovery mobility addition may be used with, for example, a binding update (BU)/binding acknowledgment (BA) or one or more other request/response MIP messages, to discover one or more other peer devices that may be registered with the HA and/or ready for IUT. Embodiments contemplate that one or more MIP Query messages may also be introduced to discover one or more other devices that may be registered and ready for IUT.

Alternatively or additionally, an HA may, without being requested to provide peer information (e.g., peer information is un-requested), attach an updated peer list, using the Mobility Addition for Peer Discovery, when the HA may send a response to a request (e.g., BA or one or more other response message). In other words, the HA may send the peer list to the peer nodes by attaching the list to a response to messages or requests other than for an updated peer list or for peer information.

Alternatively or additionally, embodiments contemplate that an HA may send an updated peer list to one or more peer device using a message such as a MIP message, where the MIP message may be unsolicited. In other words, the MIP message including the peer information may not be sent in response to a message from the one or more peer devices. The HA may send the updated peer list or peer information with a Peer Indication (PI), which may be an introduced MIP message, or the peer information may be sent with one or more existent MIP response messages. Embodiments contemplate that when the HA may send the updated peer list without being prompted by a prior request, the sequence number, for example, may be set to zero.

Embodiments contemplate that the Binding Identification (Binding ID or BID) mobility extension in BU/BA may enable the creation of multiple binding entries on a Home Agent (HA) or Correspondent Node (CN), where multiple CoAs may be associated with a Home Address (HoA). Embodiments also contemplate that a WTRU may generate a BID for each CoA.

Embodiments contemplate that a WTRU Identification (WTRU ID or UE ID, or Node ID) may be added to a binding. As discussed previously, some or all devices associated with a specific subscriber may be registered with a HA and may share the same HoA. A Binding Update (BU) using an WTRU ID extension may be sent to the HA by some or all devices. Different binding entries, that may share the same HoA but may have different CoAs/WTRU IDs, may be saved on the HA such that binding entries in the binding table may now be uniquely identified using an HoA/BID/WTRU ID triplet, as seen in the peer list in FIG. 3, for example.

As disclosed previously, the HA may utilize Mobile Internet Protocol (MIP) to accept and communicate messages. For purposes of example, and not limitation, a mobile protocol such as MIPv6 may be used. An HA may use MIP for receiving an MIP message containing a Peer Discovery mobility addition, such as a query request, BU, among others, for example. The HA may respond by using the corresponding response message (e.g. a BA may be sent as a response to BU). Embodiments contemplate that some or all WTRUs that may share the same HoA with the WTRU making the peer information inquiry may be included in the response. Embodiments contemplate that the Peer Discovery Addition may be used to encode the peer list.

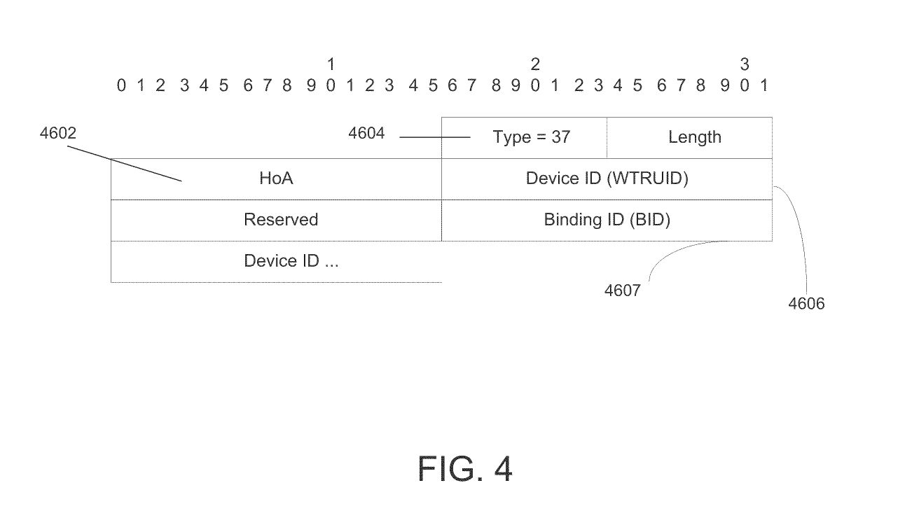

FIG. 4 illustrates an example of the Peer Discovery extension, which has not heretofore been used in MIP. Embodiments contemplate that the Peer Discovery extension may be included in one or more MIP messages, e.g. the Binding Update, Binding Acknowledgement and Binding Refresh, among others. The Peer Discovery extension may be used to query an HA. Embodiments contemplate that the HoA and the current WTRU ID may be specified, and in some embodiments only the HoA and the current WTRU ID may be specified and not a WTRU IDs list. Additionally or alternatively, embodiments contemplate that WTRU IDs list may be specified. Embodiments contemplate that the Peer Discovery extension may be used by the HA to send the list of peers sharing the same HoA, even if not requested on the BU (e.g., with an indication message). The example of FIG. 4 illustrates how the Peer Discovery extension may be implemented in MIPv6, but other formats may also be used. Referring to FIG. 4, at 4602, the HoA may be shared by some or all WTRU IDs specified in the extension. At 4604, a value “37” may be used as an example for the Peer Discovery extension type. Alternatively, the value may be any value not already used in MIPv6 or related drafts. At 4606, some or all WTRU IDs that may be registered with the HA may be listed. At 4607, requested or required information (e.g. BID) may also be included in the list as well.

Embodiments contemplate that an HA may receive a new MIP client registration, and the HA may keep registration information locally and may send a peer list or peer information if requested, and in some embodiments only if requested. Alternatively or additionally, the HA may keep the registration information locally and may attach an updated list of peers (or updated peer information) on a message sent in response to a request received (e.g. attached to BA in response to a BU). Alternatively or additionally, the HA may send an unsolicited MIP Peer Indication (PI) message to some or all peers sharing the same HoA. For example, the peer indication message may be sent by the HA without the HA receiving any message that may require a response on the part of the HA.

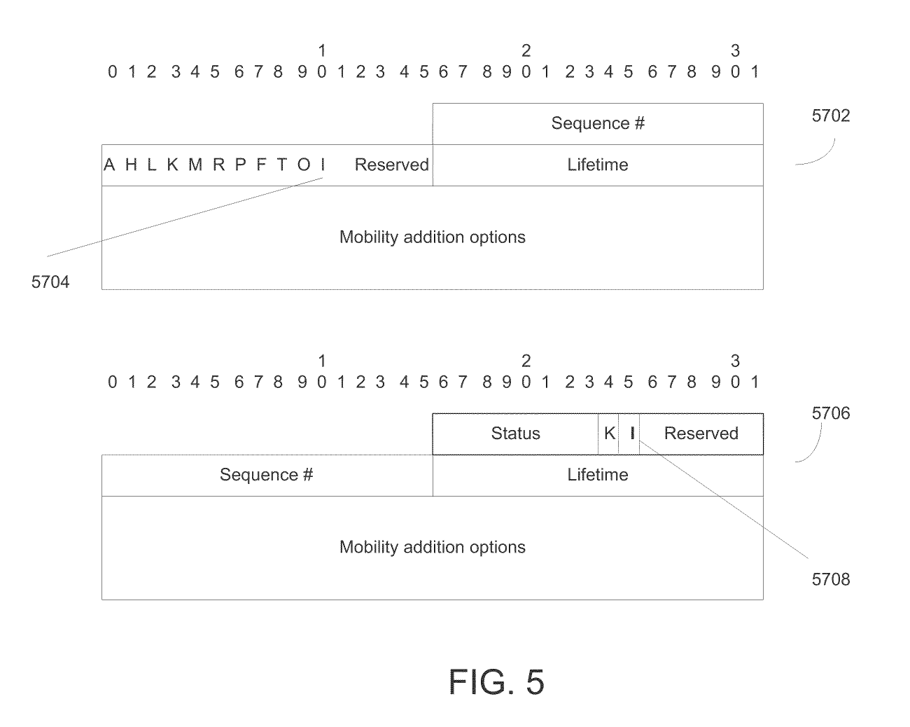

FIG. 5 illustrates an example extended binding update/acknowledge message. Embodiments contemplate that an Extended Binding Update may be made by adding indication capability, e.g., ‘I’ bit (for example). This bit may be set by the WTRUs in sent messages when “indications” may be supported. An HA may also set this bit in sent messages when/if the HA may support indications. Referring to FIG. 5, in 5702 there may be an exemplary Binding Update (BU). At 5704, there may be an “indication support” bit in the BU heretofore unused. At 5706, there may be an exemplary Binding Acknowledge (BA). At 5708, there may be an “indication support” bit in the BA heretofore unused.

Embodiments contemplate that an HA may receive an MIP client (e.g., a WTRU) deregistration or that an MIP client registration may expire. Embodiments contemplate the peer list on the HA may be updated. Also, embodiments contemplate actions similar to those conducted upon receipt of a new MIP client registration may be conducted upon receipt of an MIP client deregistration. For example, when peer information is updated due to a MIP client deregistration or registration expiration, an HA may wait for a query request, wait for any request, and/or send an unsolicited indication to inform some or all remaining peers of the updated peer information.

Embodiments contemplate that an MIP client (such as, for example WTRU 3008, WTRU 3010, and/or WTRU 3012 of FIG. 3) may utilize mobile internet protocol to accept and communicate messages. For purposes of example, and not limitation, a mobile protocol such as MIPv6 may be used. MIP clients may send query requests. Embodiments contemplate that an MIP client may send a peer list query request, using either a MIP query message or one or more other MIP request messages (e.g., a BU) that may include the peer discovery addition. An MIP client may send a query message or a message with the peer discovery addition whenever the MIP client may need to know one or more of the MIP client's peers, for example. Embodiments contemplate that the MIP client may expect a peer list or peer information on a corresponding response message.

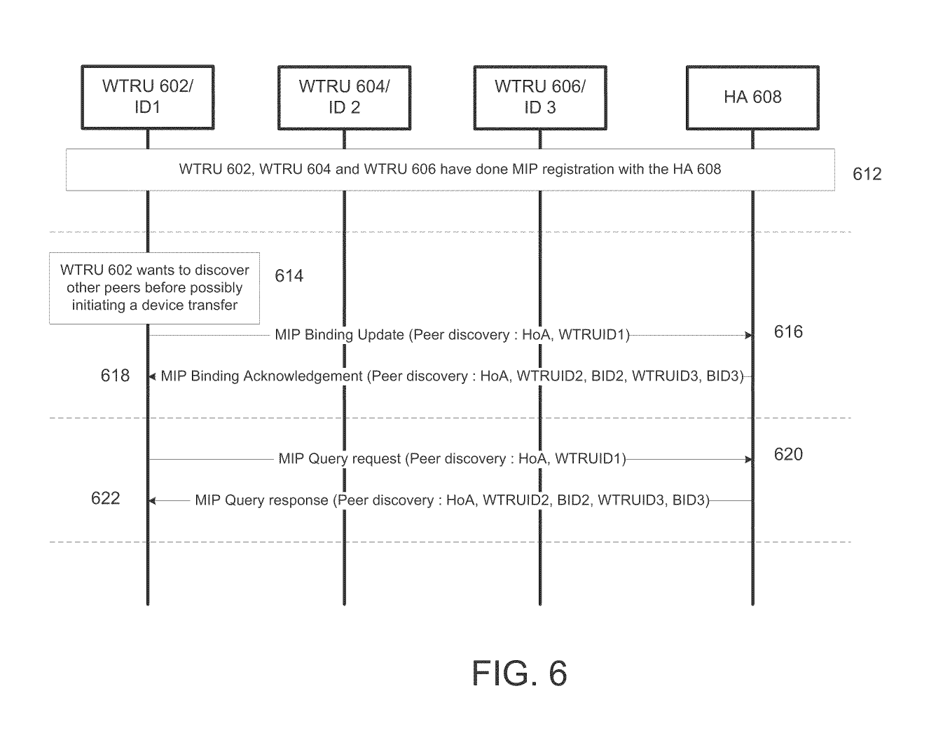

FIG. 6 illustrates an example of a contemplated peer discovery technique using an MIP based query message or a message with the peer discovery addition to obtain peer information. In FIG. 6, at 612, WTRU 602, WTRU 604 and WTRU 606 may have done MIP registration with the HA 608 in a manner similar to that described with regard to FIG. 3. At 614, WTRU 602 may undertake to discover other potential peers before possibly initiating a device transfer, for example. At 616 an MIP Binding Update message that may include the peer discovery addition may be used by WTRU 602 to query the HA 608 for peer information. At 618, the MIP Binding Acknowledgment may include the list of peers and their related information for WTRU 602. Additionally or alternatively, at 620, WTRU 602 may send an MIP query request message that may include the peer discovery addition to query the HA 608 for peer information. At 622, HA 608 may send an MIP query response message that may include the list of peers and their related information for WTRU 602.

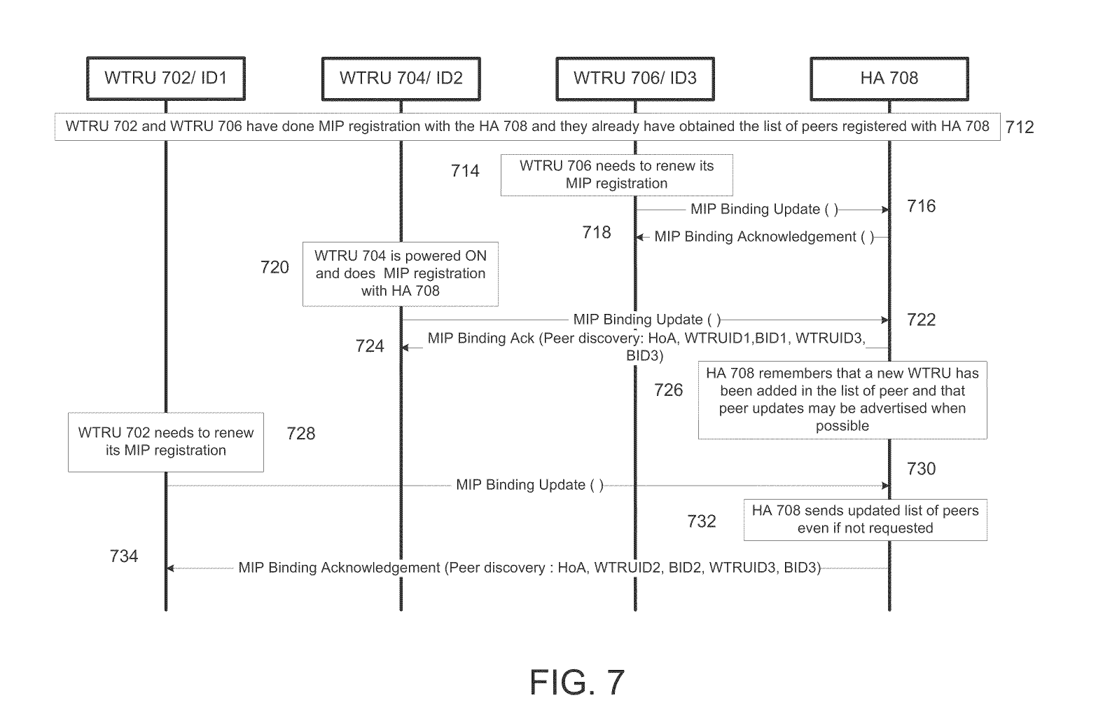

Embodiments contemplate that the MIP client may receive peer information in situations where the MIP client may not have specifically requested the peer information. Embodiments contemplate that an MIP client may receive the peer list or peer information as part of an MIP response message that may include the peer discovery addition, even when a message to which the response was sent may not have included a request for peer information (e.g., the peer information was un-requested). FIG. 7 illustrates an exemplary scheme that uses a MIP response message with un-requested peer information contemplated by embodiments. Referring to FIG. 7, at 712, WTRU 702 and WTRU 706 may have done MIP registration with the HA 708 in a manner similar to that described in regard to FIG. 3. Also WTRU 702 and WTRU 706 may already have obtained the list of peers registered with HA 708. At 714, WTRU 706 may determine to renew its MIP registration with HA 708. At 716, WTRU 706 may send a Binding Update message to HA 708 to update its MIP registration. At 718, HA 708 may send a Binding Acknowledgement message in response to the Binding Update message. The Binding Update message at 716 may not include a peer list or peer information request and the Binding Acknowledgement message at 718 may not be sent with the peer list or peer information.

At 720, WTRU 704 may be powered ON and may do MIP registration with HA 708 in a manner similar to the technique disclosed with regard to FIG. 3, for example. At 722, WTRU 704 may send an MIP Binding Update message that may not include the peer discovery addition. At 724, HA 708 may send the list of peers (or peer information) to WTRU 704 with an MIP Binding Acknowledgement message that may include the peer discovery addition, even though the peer information was not requested at 722. At 726, HA 708 may remember that WTRU 704 has been added in the list of peers and that the updated peer list information may be advertised when possible. At 728, WTRU 702 may determine to renew its MIP registration with HA 708. At 730, WTRU 702 may send a Binding Update message to HA 708 to update its MIP registration, where the Binding Update message may not include a request for a peer list or peer information. At 732, HA 708 may determine to send an updated list of peers or updated peer information to WTRU 702 in response to the Binding Update message even if not requested in the Binding Update message. At 734, HA 708 may send an un-requested updated peer list or peer information to WTRU 702 with a Binding Acknowledgement message that may include the peer discovery addition in response to the Binding Update message. WTRU 702 may update its local list of peers and may eventually initiate a device transfer to another peer WTRU 704 and/or WTRU 706, for example.

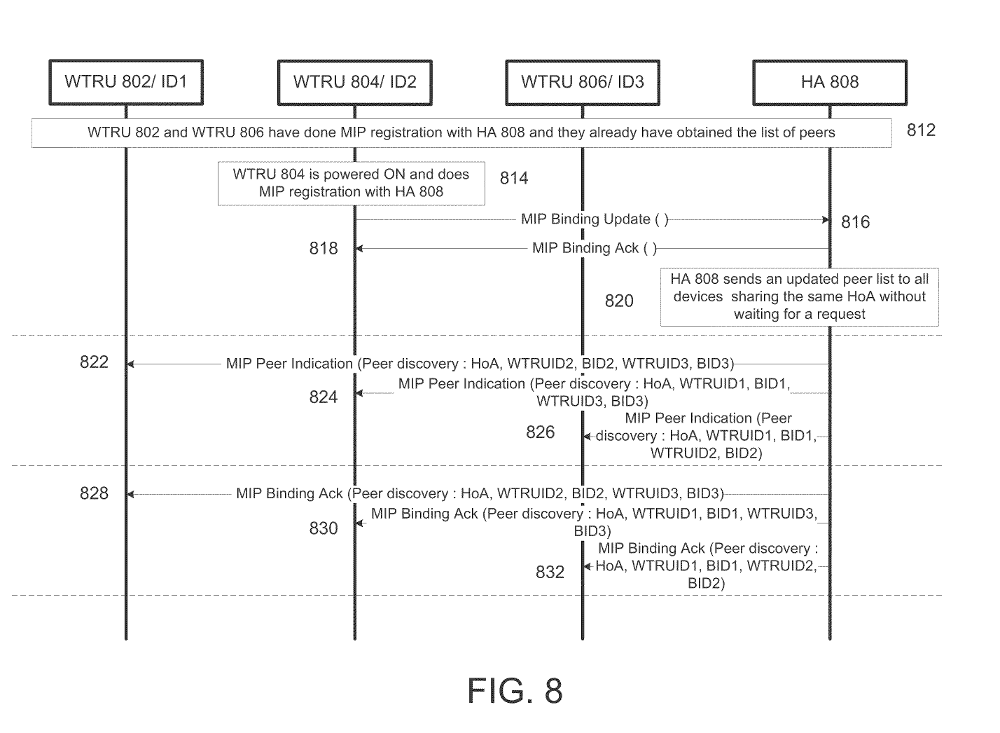

Alternatively or additionally, embodiments contemplate that an MIP client may receive an indication message carrying a peer list or peer information, where the MIP indication message may not be in response to a request message. In other words, the MIP indication message may be sent to a recipient node even though the recipient node may not have solicited the indication message, or any message, from the sending node. FIG. 8 illustrates an exemplary MIP based indication technique that provides an updated peer list or peer information without receiving a message that may require a response thereto. Referring to FIG. 8, at 812, WTRU 802 and WTRU 806 may have done MIP registration with HA 808 in a manner similar to the technique described with regard to FIG. 3. Also, WTRU 802 and WTRU 806 may have obtained the list of peers from HA 808. At 814, WTRU 804 may be powered ON and may perform MIP registration with HA 808. At 816, WTRU 804 may send a Binding Update message to HA 808 to update its MIP registration. At 818, HA 808 may send a Binding Acknowledgement message in response to the Binding Update message. The Binding Update message at 816 may not include a peer list or peer information request and the Binding Acknowledgement message at 818 may not be sent with the peer list or peer information.

At 820, HA 808 may determine to send an updated peer list to one or more devices that may share the same HoA without waiting for a request for such information, or without waiting for any message that may require some form of response message. The determination at 820 as to when to send the updated list may be left to the HA 808's implementation. The update may be done, for example, periodically or each time the peer list changes. At 822-832, “indication support” may be introduced in MIP protocol. Embodiments contemplate that, at 822-826, MIP Peer Indication messages that may include the peer discovery addition may be sent from the HA 808 respectively to WTRU 802, WTRU 804, and WTRU 806 to provide those WTRUs with an updated peer list or updated peer information. In some embodiments, the Peer Indication message may be an MIP message used specifically for unsolicited peer indication, and other specific messages are contemplated.

Additionally or alternatively, embodiments contemplate that, at 828-832, a response message may be used as an indication message. For example, an MIP Binding Acknowledgement (BA) message that may include the peer discovery addition may be sent from HA 808 respectively to WTRU 802, WTRU 804, and WTRU 806 to provide those WTRUs with an updated peer list or updated peer information, without any prior request message (such a Binding Update (BU) message, for example) being sent from the WTRUs. Embodiments contemplate the use of other MIP response messages for unsolicited peer indication as well.

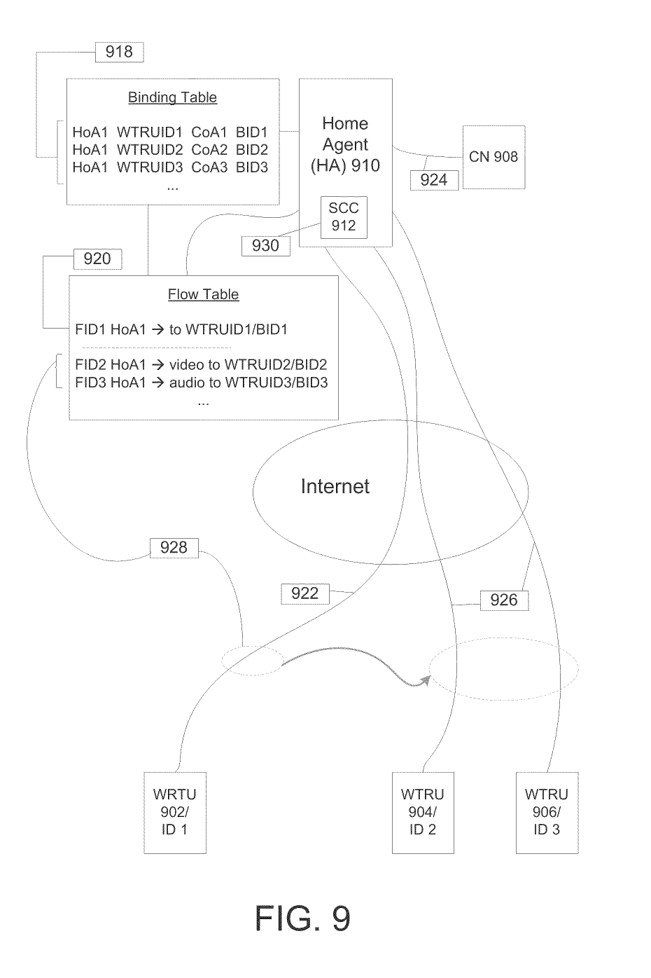

FIG. 9 illustrates an example of a system architecture for an IUT consistent with embodiments. In FIG. 9, at 918, All WTRUs (WTRU 902-WTRU 906) may be registered with HA 910 (e.g., entries may exist in a binding table). Binding entries may be uniquely identified using, for example, HoA+WTRU ID. By way of example, the WTRUID may be an international mobile equipment identity (IMEI), unique IP address or another ID. At 920-924, the traffic from the correspondent node (CN) 908 may be redirected to WTRU 902 (a traffic selector may exist in a flow table, for example). Flow entries may point to binding entries, and may be identified by BID+WTRU ID.

Embodiments contemplate that, at 926-928, an IUT may be initiated. The traffic selector redirecting traffic to WTRU 902 may be deleted while new traffic selectors redirecting video/audio to WTRU 904/WTRU 906 may be created. The traffic from the CN 908 may be redirected to WTRU 904 (video) and WTRU 906 (audio), for example. Embodiments contemplate that there may be one or more subsequent signaling to adapt the media to the target devices, for example, among other reasons. At 930, a service centralization continuity (SCC) 912 may be co-located with the HA 910 or SCC 912 can be a stand-alone entity which may require additional signaling with the HA 910. In some embodiments, WTRU 902-906 may share the same operator and/or the same subscription.

Embodiments contemplate modifications to existing MIP messaging and architectures for IUT support. New messages may also be used to the same effect of triggering an IUT operation. One or more of the new messages may use similar information elements to identify the target device, the media components to be transferred, and/or, if necessary, any adjustment in QoS.

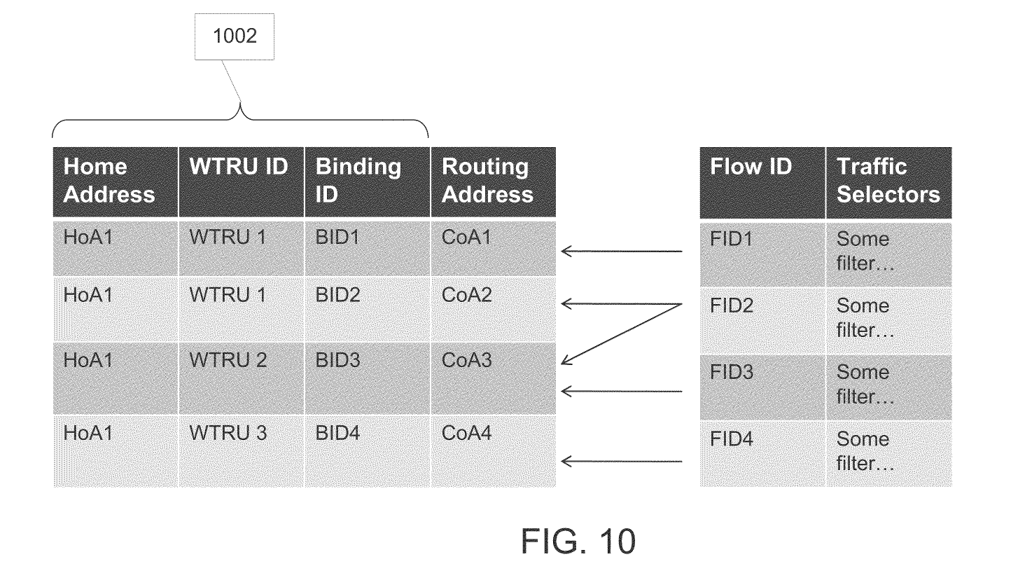

Embodiments contemplate that some or all devices that may be associated with a specific subscriber may be registered with an HA and may share the same HoA. A BU message that may use the WTRU ID extension may be sent to the HA by some or all devices. Different binding entries, such as those that may share the same HoA but may have different CoAs/WTRUIDs, may be saved on the HA, an example of which is illustrated in FIG. 10. Target devices may be registered with the HA before an IUT procedure may be initiated for one or more of these devices. Flow bindings, such as those that may specify to which binding a specific flow should be redirected, may be created, modified, and/or deleted using the HoA/WTRUID/BID triplet, for example. Separate flows may be registered (e.g., for voice, video, etc.) using traffic selectors. Embodiments contemplate that different flows may be handled separately and may be forwarded to different target WTRUs, (e.g., video may be forwarded to a first WTRU and voice to a second WTRU).

Embodiments contemplate that, in an HA and correspondent node (CN) operation, for example, a binding cache may be searched with a WTRU ID and BID or FID. Referring to FIG. 10, a binding lookup (e.g., a search into a binding table) done by the HA when receiving BUs from WTRUs may be modified. The HA may look at the HoA, where multiple entries may exist, for example. The HA may also look at the WTRU ID and/or BID, where multiple entries may exist, for example. Embodiments contemplate that a WTRU may register multiple CoAs which may correspond to multiple BIDs that may be generated by the WTRU. Also, the HA may look at the FID for which, by way of example, multiples entries may be found, and in some embodiments, one or perhaps no entry may be found. Embodiments contemplate that when receiving data traffic, the HoA may be looked at and then associated FIDs may be looked at to determine where the data should be redirected. For example, an FID may point to a BID/WTRU ID pair. The WTRUID and then BID may be looked up to find the CoA indicating where to forward the data (e.g., media flow). Embodiments contemplate that some or all binding entries related to a specific device may be removed in appropriate circumstances. For example, a de-registration binding update (with lifetime set to 0) may be sent specifying the HoA and/or the WTRUID to de-register.

FIG. 10 illustrates an exemplary binding table when a WTRUID may be added to a binding entry and flow binding. FIG. 10 shows an example of the resulting binding table assuming a user has three devices (same HoA, and different WTRUIDs). The WTRU1 may have 2 interfaces, and WTRU2 and WTRU3 may have one interface. FID2 is an example of multiple destinations (e.g., packet duplication). Embodiments contemplate that BIDs and FIDs may be unique per HoA/WTRUID pair, plus either BID or FID. At 1002, a binding entry may be uniquely identified by HoA/WTRUID/BID triplet. Some or all mobility options using HoA/BID and/or HoA/FID as a binding entry key may be modified to also include the WTRUID (e.g., with binding refresh (BR)).

Embodiments contemplate one or more MIP based IUT techniques. Embodiments contemplate that IUT to other WTRUs may be initiated by a device user (e.g., manual input) and/or may be automatically triggered (e.g., based on pre-configuration). For example, a policy that may be stored on an HA or on a WTRU may indicate a time of day to redirect a media flow, or a component of a media flow, from one of the user's WTRUs (e.g., a smart phone) to another of the user's WTRU (e.g., a television connected to an IP network).

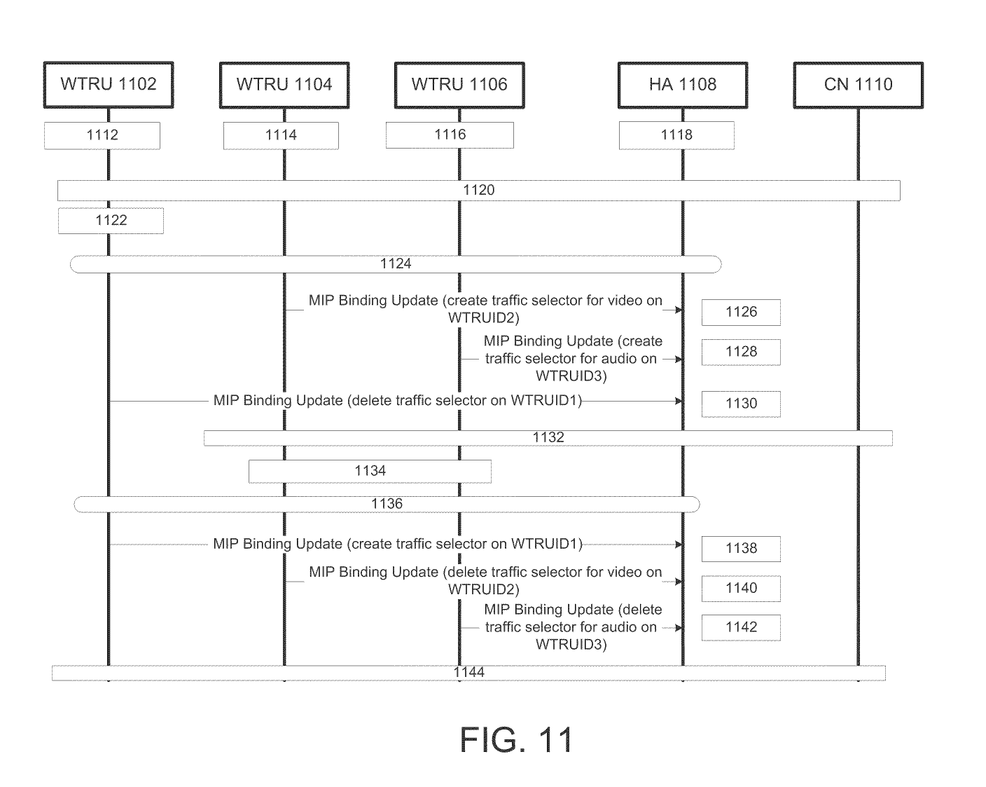

FIG. 11 illustrates an IUT scheme implemented with an independent controller technique contemplated by embodiments. In the IUT illustrated in FIG. 11, one or more of the WTRUs 1102-1106 may be responsible of creating, deleting, or changing its own traffic selectors on the HA 1108, which may have the effect of redirecting data traffic to itself or to another WTRU, for example. In FIG. 11, by way of example, and not limitation, WTRU 1102 may be a smartphone, WTRU 1104 may be a television, WTRU 1106 may be a sound system, and CN 1110 may be a streaming media server. At 1112, WTRU 1102 may be registered with HA 1108 with HoA_Y, WTRUID1, and CoA1 and may be receiving a TV program, for example. At 1114, WTRU 1104 may be registered with HA 1108 with HoA_Y, WTRUID2, and CoA2, for example. At 1116, WTRU 1106 may be registered with HA 1108 with HoA_Y, WTRU ID3, and CoA3, for example. At 1118, a traffic selector to redirect a TV program on WTRU 1102 may exist. At, 1120 streaming data may be sent to HoA_Y (via HA 1108) and may be redirected to WTRU 1102. At 1122, a user of WTRU 1102 may determine to transfer the audio/video components of the TV program to the WTRU 1104 (e.g., TV) and WTRU 1106 (e.g., sound system).

At 1124, Peer WTRU Discovery may be initiated, and WTRU 1102 may transfer control to WTRU 1104 and/or WTRU 1106. Embodiments contemplate that new traffic selectors may need to be installed on HA 1108 and that current traffic selectors may need to be deleted on HA 1108. At 1126 and 1128, WTRU 1104 and WTRU 1106 may respectively send MIP BU messages to HA 1108 to create traffic selectors to redirect video (to WTRU 1104) and to redirect audio (to WTRU 1106). At 1130, WTRU 1102 may send an MIP BU message to HA 1108 to delete the traffic selector that directed the video and audio to WTRU 1102. At 1132, streaming data may be sent to HoA_Y (via HA 1108). Video may be redirected to WTRU 1104 and audio may be redirected to WTRU 1106. At 1134, the user may determine to transfer back the streaming video and audio onto WTRU 1102. At 1136, Peer WTRU Discovery may be initiated and WTRU 1104 and WTRU 1106 may transfer control to WTRU 1102. Embodiments contemplate that a new traffic selector may be installed on the HA 1108 and that current traffic selectors may be deleted.

At 1138, WTRU 1102 may send an MIP BU message to HA 1108 to create a traffic selector that redirects the video and audio to WTRU 1102. At 1140 and 1142, WTRU 1104 and WTRU 1106 may respectively send MIP BU messages to HA 1108 to delete the traffic selectors that redirected video (to WTRU 1102) and that redirected audio (to WTRU 1106). At 1144, streaming video and audio data may be sent to HoA_Y (via HA 1107) and may be redirected to WTRU 1102.

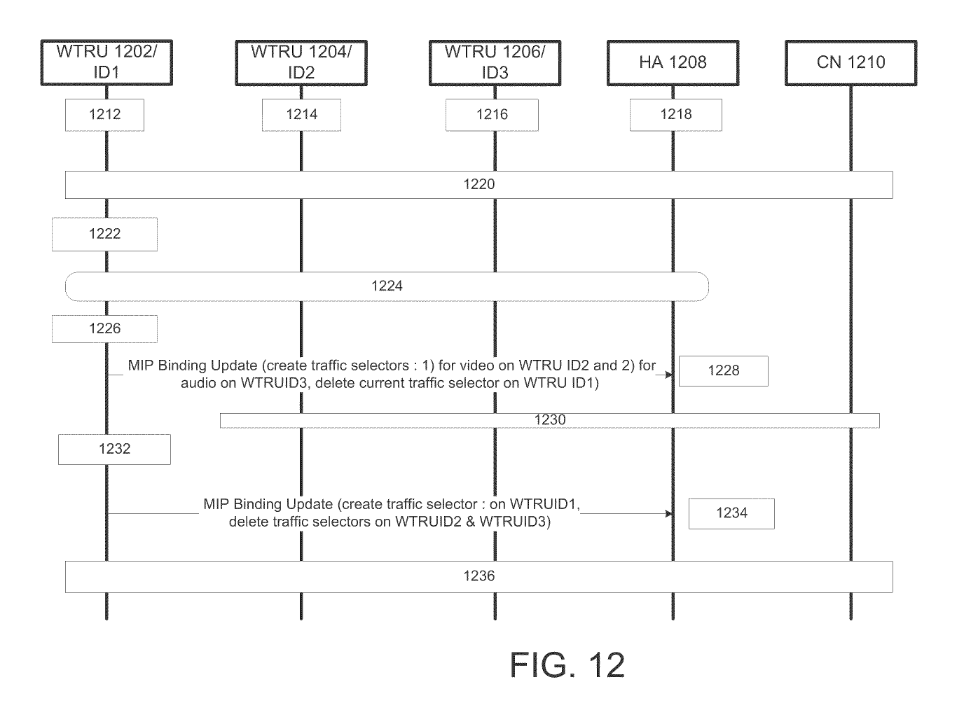

FIG. 12 illustrates an IUT scheme implemented with a master controller technique contemplated by embodiments. In the IUT scheme of FIG. 12, a WTRU (e.g., a “master controller”) may be identified as responsible for traffic selector creation, maintenance, and/or deletion on an HA that may initiate the redirection of data traffic to other devices or to the master controller WTRU. Embodiments contemplate that the master controller may be able to receive commands from a user (e.g., buttons pressed), and in some embodiments, may be the only device able to receive commands from the user. The master controller may be pre-configured (e.g., an ordered list may exist) on one or more WTRUs. Alternatively or additionally, embodiments contemplate that the master controller identity may be received from the HA (perhaps via a new “master controller” mobility extension on an MIP message, like a BA for example).

In FIG. 12, by way of example, and not limitation, WTRU 1202 may be a smartphone, WTRU 1204 may be a television, WTRU 1206 may be a sound system, and CN 1210 may be a streaming media server. Also in FIG. 12, WTRU 1202 may be designated as the master controller for the disclosed example, but other WTRUs could be the mater controller in other embodiments. At 1212, WTRU 1202 may be registered with HA 1208 with HoA_Y, WTRUID1, and CoA1 and may be receiving a TV program, for example. At 1214, WTRU 1204 may be registered with HA 1208 with HoA_Y, WTRUID2, and CoA2, for example. At 1216, WTRU 1206 may be registered with HA 1208 with HoA_Y, WTRU ID3, and CoA3, for example. At 1218, a traffic selector to redirect a TV program on WTRU 1202 may exist. At, 1220 streaming data may be sent to HoA_Y (via HA 1208) and may be redirected to WTRU 1202. At 1222, a user of WTRU 1202 may determine (e.g., perhaps with the operation of one or more buttons) to transfer the audio/video components of the TV program to the WTRU 1204 (e.g., TV) and WTRU 1206 (e.g., sound system).

At 1224, Peer WTRU Discovery may be initiated, and WTRU 1202 may obtain information to modify existing flows and to redirect flow traffic to WTRU 1204 and/or WTRU 1206. At 1226, embodiments contemplate that WTRU 1202 may determine to create new traffic selectors to redirect data flow to WTRU 1204 and/or WTRU 1206 and may determine to delete current traffic selectors. At 1228, WTRU 1202 may send an MIP BU message to HA 1208 to create traffic selectors to redirect video (to WTRU 1204) and to redirect audio (to WTRU 1206). The MIP BU message to HA 1208 may also delete the traffic selector that directed the video and audio to WTRU 1202. At 1230, streaming data may be sent to HoA_Y (via HA 1208). Video may be redirected to WTRU 1204 and audio may be redirected to WTRU 1206. At 1232, the user may determine to transfer back the streaming video and audio onto WTRU 1202. At 1234, WTRU 1202 may send an MIP BU message to HA 1208 to create traffic selectors to redirect audio and video to WTRU 1202. The MIP BU message to HA 1208 may also delete the traffic selectors that directed the video to WTRU 1204 and the audio to WTRU 1206. At 1236, streaming data (audio & video) may be sent to HoA_Y (via HA) and may be redirected to WTRU 1202.

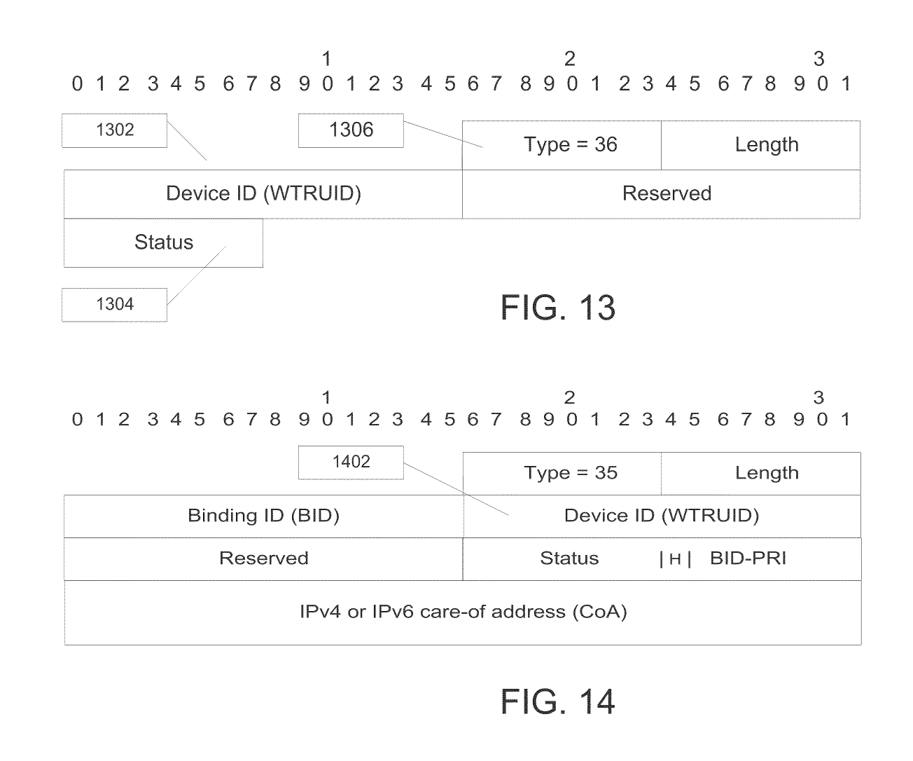

FIG. 13 illustrates an example of a WTRUID extension implemented in MIP consistent with embodiments. The WTRUID extension may be a new mobility addition (option). This extension may be included in one or more MIP messages, e.g., the Binding Update (BU), Binding Acknowledgment (BA), and/or Binging Refresh (BR). This extension may be used in conjunction with a BID mobility option that may, for example, uniquely identify a binding entry for a specific device. Embodiments contemplate that, at 1302, a device ID may be, but is not limited to, an IMEI, serial number, IP address (perhaps if unique), and/or a predefined number that may be unique per HoA, among others. FIG. 13 illustrates an example of how this extension may be implemented in MIP, for example MIPv6. Embodiments contemplate that other formats may be used. For example, 16 bits may be used with 16 more bits reserved for future use. At 1304, a status may have a meaning (e.g., success or failure) when used in a binding acknowledgement, for example. At 1306, a value “36” may be used as an example. Embodiments contemplate that the value may be a value that may not already be used in MIPv6 or related drafts, for example.

FIG. 14 illustrates an example of a WTRUID extension that may be added to a binding identifier mobility addition (option) in MIP, for example MIPv6. Embodiments contemplate that the WTRUID may be added to the BID mobility addition (option). A WTRUID of value zero, for example, may be interpreted as no WTRUID specified. The device ID may be (but is not limited to) an IMEI, serial number, IP address (perhaps if unique), and/or a predefined number that may be unique per HoA, among others. FIG. 14 shows an example of how this extension may be implemented in MIPv6. Embodiments contemplate that other formats may be used. For example, 16 bits may be used with 16 more bits reserved for future use, for example. At 1402, the WTRU ID may be added to uniquely identify a binding entry, for example.

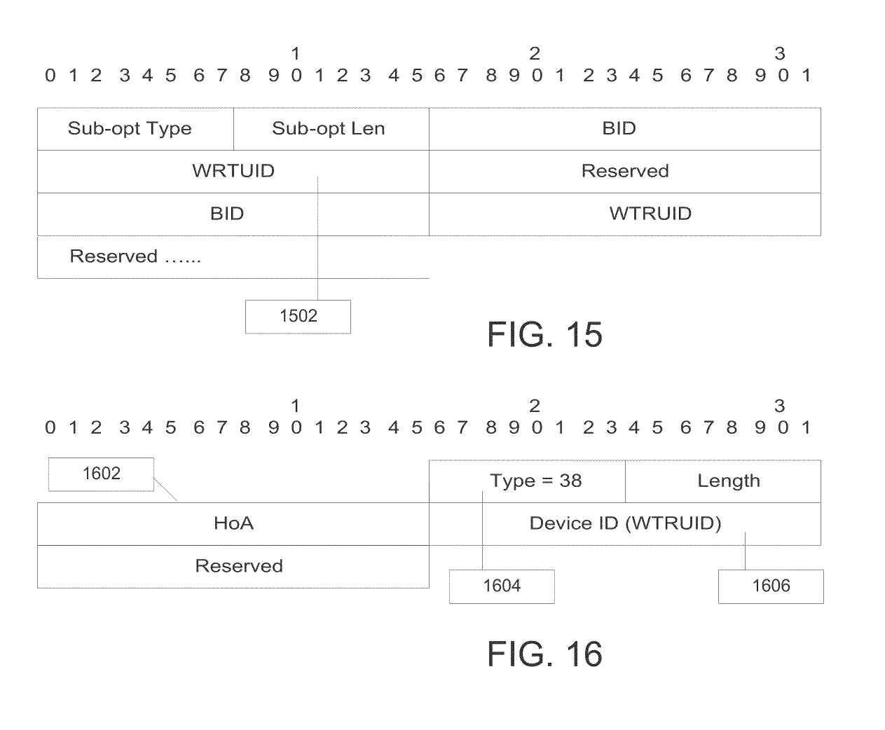

FIG. 15 illustrates an example of a WTRUID extension that may be added to a binding reference sub-option in MIP, for example MIPv6. Embodiments contemplate that the binding reference sub-option introduced to support flow bindings may be modified to include the WTRUID. A binding entry may be uniquely identified using an HoA/WTRUID/BID triplet, for example. A value of zero, for example, may be interpreted as no WTRUID specified. FIG. 15 shows an example of how this extension may be implemented in MIPv6. Embodiments contemplate that other formats may be used. For example, 16 bits may be used with 16 more bits reserved for future use. At 1502, embodiments contemplate that the WTRUID may be added to form the binding entry key with the BID, for example.

FIG. 16 illustrates an example of a master controller extension that may be implemented in MIP, for example MIPv6. The master controller extension may be a new mobility addition (option), for example. This extension may be included in one or more MIP messages, e.g., the BU, BA and BR, among others. A peer may query a HA by sending this extension that may specify a HoA, and in some embodiments may specify only the HoA (e.g., not a device ID). This extension may be used by the HA to send the master controller of peers that may share the same HoA. FIG. 16 shows an example of how this extension may be implemented in MIPv6. Embodiments contemplate that other formats may be used. At 1602, a HoA may be specified on the Query (BU) and/or on the BA. At 1604, a value “38” may be used as an example. Embodiments contemplate that the value may be a value that may not already be used in MIPv6 or related drafts, for example. At 1606, the master controller may be specified and, in some embodiments only the master controller may be specified. Embodiments contemplate that zero may be used if no master controller may exist.

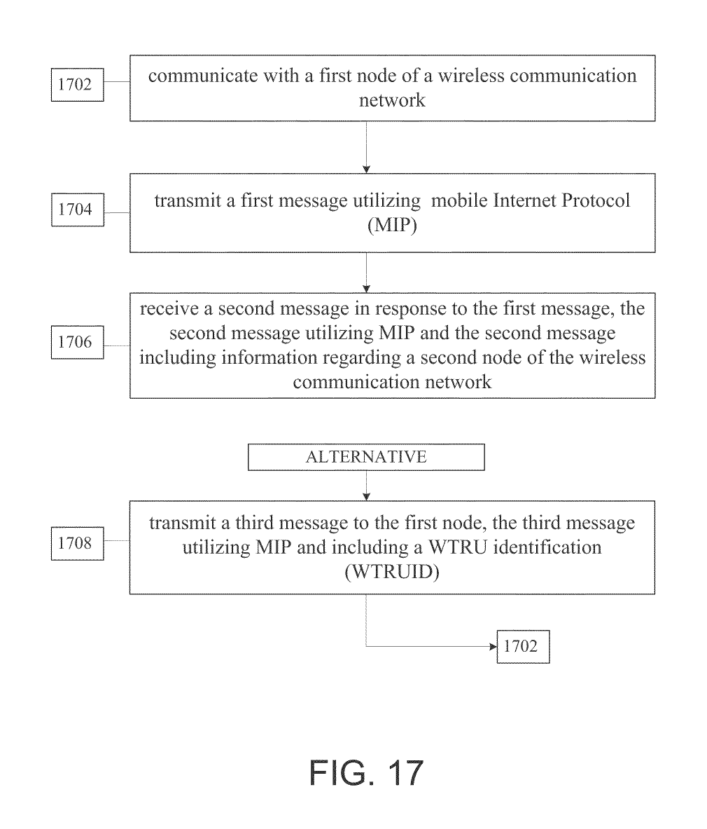

In light of the previous disclosure, referring to FIG. 17, embodiments contemplate that a wireless transmit/receive unit (WTRU) may be configured, at least in part, at 1702, to communicate with a first node of a wireless communication network and, at 1704, to transmit a first message. The first message may utilize mobile Internet Protocol (MIP). The WTRU may also be configured, at 1706, to receive a second message in response to the first message. The second message may utilize MIP and the second message may include information regarding a second node of the wireless communication network. The second node may be configured or configurable to communicate with the first node. Embodiments contemplate that the first node may be a home agent, and the WTRU and/or the second node may be registered with the home agent. Embodiments contemplate that the second node may be another WTRU and the information regarding the second node may include at least one of a home address (HoA), a node identification (Node ID) (that may also be a WTRU ID), a binding identification (Binding ID), a routing Care of Address (CoA), and/or a flow identification (Flow ID).

Alternatively or additionally, embodiments contemplate that the WTRU may be configured, at 1708, to transmit a third message to the first node. The third message may utilize MIP and the third message may include a WTRU identification (WTRU ID) in at least one of a WTRU ID extension or a binding identifier extension. The third message may provide information regarding the WTRU which the first node may use to register the WTRU. The WTRU ID may be at least one of an International Mobile Equipment Identifier (IMEI), a WTRU serial number, an Internet Protocol (IP) address, and/or a predetermined number.

Embodiments contemplate that the first message may be transmitted to the first node, which may be a home agent, and the first message may include a first extension. The first extension may indicate a request of the WTRU for the information regarding the second node. Embodiments contemplate that the first message may be at least one of a binding update or a query request. Embodiments contemplate that the second message may be received from the home agent and that the second message may include a second extension. The second extension may include the information regarding the second node. Embodiments contemplate that the second message may be at least one of a binding acknowledgement or a query response.

Alternatively or additionally, the first message may be transmitted to the first node, which may be a home agent, and the first message may include no indication of a request of the WTRU for the information regarding the second node. Embodiments contemplate that the second message may be received from the home agent and that the second message may include an extension, where the extension may include the information regarding the second node.

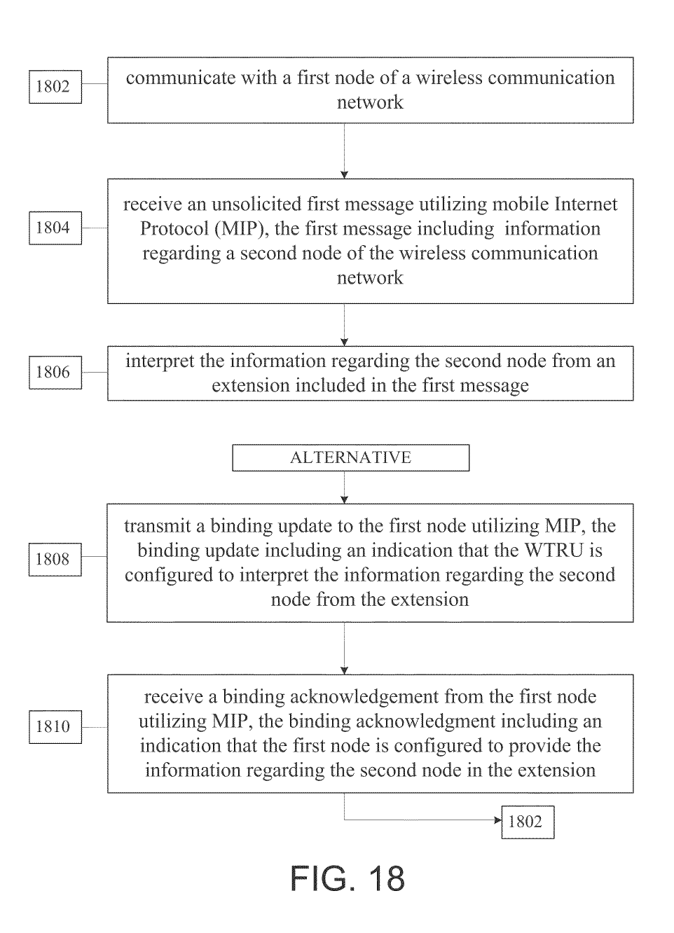

Referring to FIG. 18, embodiments contemplate a wireless transmit/receive unit (WTRU) that may be configured, at least in part, at 1802, to communicate with a first node of a wireless communication network and, at 1804, to receive a first message. The first message may be unsolicited and may utilize mobile Internet Protocol (MIP), and the first message may include information regarding a second node of the wireless communication network. The second node may be configured or configurable to communicate with the first node. Embodiments contemplate that the first node may be a home agent, and at least one of the WTRU or the second node may be registered with the home agent.

Embodiments contemplate that the first message may be received from the first node, which may be a home agent, and the first message may include an extension, where the extension may include the information regarding the second node. Embodiments contemplate the WTRU may be further configured, at 1806, to interpret the information regarding the second node from the extension.

Alternatively or additionally, embodiments contemplate that, at 1808, the WTRU may be further configured to transmit a binding update to the first node. The binding update may utilize MIP and the binding update may include an indication that the WTRU may be configured to interpret the information regarding the second node from the extension. The WTRU may also be configured, at 1810, to receive a binding acknowledgement from the first node. The binding acknowledgement may utilize MIP and the binding acknowledgment may include an indication that the first node may be configured to provide the information regarding the second node in the extension.

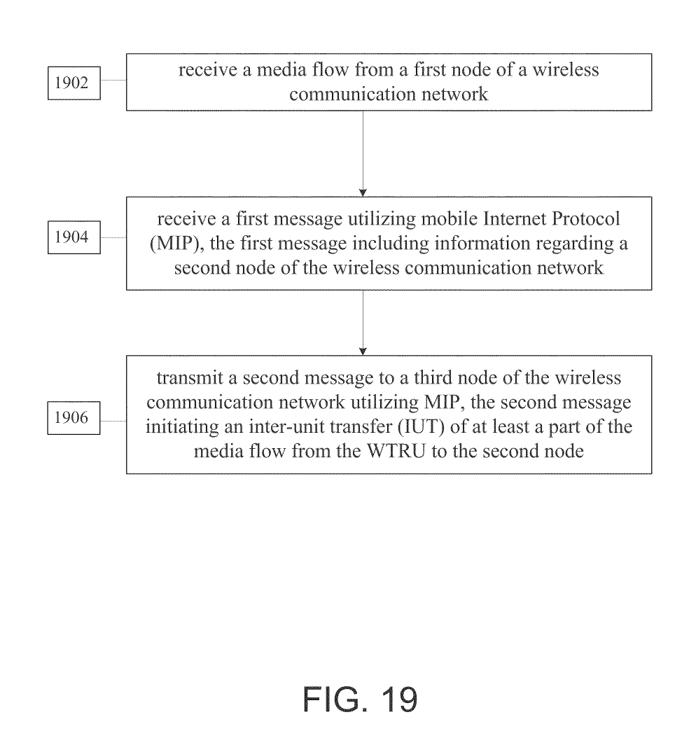

Referring to FIG. 19, embodiments contemplate a wireless transmit/receive unit (WTRU) may be configured, at least in part, at 1902, to receive a media flow from a first node of a wireless communication network and, at 1904, to receive a first message that may include information regarding a second node of the wireless communication network. The first message may utilize mobile Internet Protocol (MIP). The WTRU may also be configured, at 1906, to transmit a second message to a third node of the wireless communication network. The second message may utilize MIP and the second message may initiate an inter-unit transfer (IUT) of at least a part of the media flow from the WTRU to the second node. Embodiments contemplate that the second node may be another WTRU and the information regarding the second node may include at least one of a home address (HoA), a node identification (Node ID) (that also may be a WTRU ID), a binding identification (Binding ID), a routing Care of Address (CoA), or a flow identification (Flow ID).

Embodiments contemplate the second message may initiate the IUT, at least in part, by at least one of deleting a first traffic selector corresponding to the WTRU or creating a second traffic selector corresponding to the second node. The second traffic selector may be stored on the third node and the second traffic selector may indicate a flow direction of the at least part of the media flow to the second node. The second traffic selector may correspond to a Flow ID and the Flow ID may correspond to at least one of a Binding ID, a HoA, or a Node ID (that may also be a WTRU ID). Embodiments contemplate that the third node may be a home agent, and at least one of the WTRU or the second node may be registered with the home agent, and the first node may be a streaming media server.

While the various embodiments have been described in connection with the various figures, it is to be understood that other similar embodiments may be used or modifications and additions may be made to the described embodiment for performing the same function of the various embodiments without deviating there from. Therefore, the embodiments should not be limited to any single embodiment, but rather should be construed in breadth and scope in accordance with the appended claims.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A wireless transmit/receive unit (WTRU), the WTRU configured, at least in part, to:
communicate with a first node of a wireless communication network;
transmit a first message, the first message utilizing mobile Internet Protocol (MIP); and
receive a second message in response to the first message, the second message utilizing MIP and the second message including information regarding a second node of the wireless communication network, the second node being configurable to communicate with the first node.

2. The WTRU of claim 1, wherein the first node is a home agent, and at least one of the WTRU or the second node are registered with the home agent.

3. The WTRU of claim 2, wherein the second node is another WTRU and the information regarding the second node includes at least one of a home address (HoA), a WTRU identification (WTRU ID), a binding identification (Binding ID), a routing Care of Address (CoA), or a flow identification (Flow ID).

4. The WTRU of claim 1, wherein the WTRU is further configured to:
transmit a third message to the first node, the third message utilizing MIP and the third message including a WTRU identification (WTRU ID) in at least one of a WTRU ID extension or a binding identifier extension, the WTRU ID being at least one of an International Mobile Equipment Identifier (IMEI), a WTRU serial number, an Internet Protocol (IP) address, or a predetermined number.

5. The WTRU of claim 2, wherein the first message is transmitted to the home agent and the first message includes a first extension, the first extension indicating a request of the WTRU for the information regarding the second node.

6. The WTRU of claim of 5, wherein the first message is at least one of a binding update or a query request.

7. The WTRU of claim 5, wherein the second message is received from the home agent and the second message includes a second extension, the second extension including the information regarding the second node.

8. The WTRU of claim 7, wherein the second message is at least one of a binding acknowledgement or a query response.

9. The WTRU of claim 2, wherein the first message is transmitted to the home agent and the first message includes no indication of a request of the WTRU for the information regarding the second node.

10. The WTRU of claim 9, wherein the second message is received from the home agent and the second message includes an extension, the extension including the information regarding the second node.

11. A wireless transmit/receive unit (WTRU), the WTRU configured, at least in part, to:
communicate with a first node of a wireless communication network; and
receive a first message, the first message being unsolicited and utilizing mobile Internet Protocol (MIP), and the first message including information regarding a second node of the wireless communication network, the second node being configurable to communicate with the first node.

12. The WTRU of claim 11, wherein the first node is a home agent, and at least one of the WTRU or the second node are registered with the home agent.

13. The WTRU of claim 11, wherein the first message is received from the first node and the first message includes an extension, the extension including the information regarding the second node.

14. The WTRU of claim 13, wherein the WTRU is further configured to:
interpret the information regarding the second node from the extension;
transmit a binding update to the first node, the binding update utilizing MIP and the binding update including an indication that the WTRU is configured to interpret the information regarding the second node from the extension; and
receive a binding acknowledgement from the first node, the binding acknowledgement utilizing MIP and the binding acknowledgment including an indication that the first node is configured to provide the information regarding the second node in the extension.

15. A wireless transmit/receive unit (WTRU), configured, at least in part, to:
receive a media flow from a first node of a wireless communication network;
receive a first message including information regarding a second node of the wireless communication network, the first message utilizing mobile Internet Protocol (MIP); and
transmit a second message to a third node of the wireless communication network, the second message utilizing MIP and the second message initiating an inter-unit transfer (IUT) of at least a part of the media flow from the WTRU to the second node.

16. The WTRU of claim 15, wherein the second node is another WTRU and the information regarding the second node includes at least one of a home address (HoA), a WTRU identification (WTRU ID), a binding identification (Binding ID), a routing Care of Address (CoA), or a flow identification (Flow ID).

17. The WTRU of claim 15, wherein the second message initiates the IUT, at least in part, by at least one of deleting a first traffic selector corresponding to the WTRU or creating a second traffic selector corresponding to the second node.

18. The WTRU of claim 17, wherein the second traffic selector is stored on the third node, the second traffic selector indicating a flow direction of the at least part of the media flow to the second node.

19. The WTRU of claim 18, wherein the second traffic selector corresponds to a Flow ID and the Flow ID corresponds to at least one of a Binding ID, a HoA, or a WTRU ID.

20. The node of claim 15, wherein the third node is a home agent, and a least one of the WTRU or the second node are registered with the home agent, and the first node is a streaming media server.
